(19) United States
(12) Patent Application Publication
(10) Pub. No.: US 2008/0261312 A1
(43) Pub. Date: Oct. 23, 2008

(54) Methods for matrix cleanup and analysis of drugs and metabolites in biological matrices

(76) Inventor: Yuhui Yang, Hackettstown, NJ (US)

Correspondence Address: YUHUI YANG, 621 MANSFIELD VILLAGE, HACKETTSTOWN, NJ, 07840, US

(21) Appl. No.: 11/511,072

(22) Filed: Apr. 18, 2007

(51) Int. Cl. G01N 33/48

(52) U.S. Cl. 436/18

(57) ABSTRACT

The invention is directed to the use of weak anion exchange (WAX) materials for trapping of negative and zwitterionic interferences from biological matrices, and then reduction of the biological matrix effect in the quantitative analysis process of basic and neutral compounds present in the matrix. The sample preparation process includes adding the WAX cleanup step before or after or during the conventional extraction procedures like liquid-liquid extraction, protein precipitation, solid phase extraction and others. Such a step greatly enhances the selectivity of the extraction process via the removal of the majority of the contaminants and reduces the matrix effect in the quantitative analysis. In addition, the WAX-enhanced extraction is very simple, versatile, rug and easy to be operated.

### BRIEF INTRODUCTION

The present invention is for minimization and elimination of matrix effect in bioanalytical chemistry.

The present invention relates to the addition of WAX (weak anion-exchange) materials into the current extraction protocol(s) for cleanup of all types of biological matrices so that a wide spectrum of basic and neutral drug substances are quantitatively extracted with good recoveries and without extraneous components that would cause matrix effect during analysis.

The present invention is mainly for improving the data quality regarding pre-clinical and clinical analyses, and offering more accurate pharmacokinetic and toxicological kinetic profiles.

### CROSS-REFERENCE TO RELATED APPLICATIONS

Note: No related US and Foreign Patent Documents are found. All the references cited herein are journal articles and conference proceedings.

P. Bennett and H. R. Liang, “Overcoming matrix effects resulting from biological phospholipids through selective extractions in quantitative LC/MS/MS,” Presented at the 52nd ASMS Conference on Mass Spectrometry, Nashville, Tenn., May 2004.

P. Bennett and K. C. Van Horne, “Identification of the major endogenous and persistent compounds in plasma, serum, and tissue that cause matrix effects with electrospray LC/MS techniques”, Presented at the 2003 AAPS Annual Meeting and Exposition, Salt Lake City, Utah, October 2003.

C. Chin, Z. P. Zhang and H. T. Karnes, “A Study Of Matrix Effects On An LC/MS/MS Assay For Olanzapine And Desmethyl Olanzapine”, Journal of Pharmaceutical and Biomedical Analysis, 2004, 35, 1149-1167.

J. P. Feighner, G. Nicolau, H. Abajian, N. C. Marricco, J. Morrison, L. Sverdlov, J. Hlavka, G. Tonelli, C. Di Spirito, G. Faria, “Clinical pharmacokinetic studies with INN 00835 (nemifitide), a novel pentapeptide antidepressant”, Biopharmaceutics & Drug Disposition, 2002, 23 (1): 33-39.

R. King, R. Bonfiglio, C. Fernandez-Metzler, C. Miller-Stein and T. Olah, “Mechanistic investigation of ionization suppression in electrospray ionization”, J. Amer. Soc. Mass. Spectrom., 2000, 11, 942-950.

B. K. Matuszewski, M. L. Constanzer, and C. M. Chavez-Eng, “Strategies for the Assessment of Matrix Effect in Quantitative Bioanalytical Methods Based on HPLC-MS/MS”, Anal. Chem., 2003, 75, 3019-3030.

H. Mei, Y. Hsieh, C. Rardo, X. Xu, S. Wang, K. Ng and W. A. Korfmacher, “Investigation OF Matrix Effects In Bioanalytical High-Performance Liquid Chromatography/Tandem Mass Spectrometric Assays: Application To Drug Discovery”, Rapid Communication Of Mass Spectrometry, 2003, 17, 97-103.

M. Meng and P. Bennett, “Source for imprecision resulting from ionization suppression from strongly retained phospholipids and dioctyl phthalate,” Presented at the 52nd ASMS Conference on Mass Spectrometry, Nashville, Tenn., May 2004.

F. J. Schenck and S. J. Lehotay, “Does Further Clean-up Reduce the Matrix Enhancement in Gas Chromatographic Analysis of Pesticide Residues in Foods?”, Journal of Chromatography A., 2000, 868, 51-61.

K. C. Van Horne and P. Bennett, “Preventing matrix effects by using new sorbents to remove phospholipids from biological samples,” Presented at the 2003 AAPS Annual Meeting and Exposition, Salt Lake City, Utah, October 2003.

K. C. Van Horne, M. Meng, R. Marquardt and P. Bennett; “Investigation of analyte recoveries from a new sorbent designed to remove phospholipids and reduce associated matrix effects,” Presented at the 52nd ASMS Conference on Mass Spectrometry, Nashville, Tenn., May 2004.

T. Zhang, M. Meng, K C Van Horne and P. K. Bennett, “Implication of phospholipids in significant matrix effects in negative ion ES-MS/MS,” Presented at the 2005 AAPS Annual Meeting and Exposition, Nashville, Tenn., November 2005.

### DESCRIPTION

### Background of the Invention

1. Field of the Invention

The present invention is for minimization and elimination of matrix effect in quantitative bioanalytical chemistry. The present invention is directed to methods for extracting basic and neutral drugs (and metabolites) from biological matrices (serum, plasma, urine, bile, blood, liver, skin fat, kidney, muscle, brain and all the other biological tissues). More specifically, the present invention relates to the addition of WAX (weak anion-exchange) materials in the current extraction protocol(s) for cleanup of all types of biological matrices extracting so that a wide spectrum of basic and neutral drug substances are quantitatively extracted with good recoveries and without extraneous components that would cause interference during analysis.

2. Background Information and Prior Art

One of the main areas of activity of pharmaceutical companies, clinical hospitals, contract research laboratories, medical laboratories, forensic and toxicological laboratories, illegal drug analytical center, and veterinary drug laboratories is the determination of the concentrations of drug and its metabolites in samples of human and animal complex biological fluids/tissues (such as blood, serum, plasma, cultured cells, living or decreased organism, tumor biopsy tissue, living tissues). The data are very important in support of drug discovery and development as well as the design of the optimized medical plan to patients. It is therefore necessary that the drugs and their metabolites can be extracted with good recovery and without extraneous components that will cause interference during analysis.

The process for separating the drug(s) from the matrix is generally referred to as the sample preparation process. The need to extract only the drugs (and metabolites) from the other components of the complex biological matrix is becoming increasingly important with the extensive uses of increasingly sensitive analytical techniques like liquid chromatography/mass spectroscopy (LC/MS), liquid chromatography/tandem mass spectroscopy (LC/MS/MS) and gas chromatography/mass spectroscopy (GC/MS). These methods can accurately and precisely measure the drugs, and, if necessary, the metabolites at the low nanogram/mL and even picogram/mL levels if the sample preparation process is successful. Particularly, quantitative bioanalysis by high-throughput LC/MS/MS is very versatile and powerful in support of various stages of drug development process: from high-throughput screening of drug candidates to rapid data generation for pre-clinical studies to almost real-time analysis of clinical samples.

It is generally recognized that how to optimize the sample preparation process is the most challenging part in the majority of quantitative bioanalysis. Extraction of drugs and metabolites from biological matrices is presently achieved by one of three procedures: liquid-liquid extraction, off-line solid phase extraction and on-line solid phase extraction. Each of the specific methods will be briefly described as follows:

(a). Acetonitrile protein precipitation: In a few cases, methanol, acetone, ethyl acetate or mixed solvents are use instead of acetonitrile. This method has low selectivity. In almost all the cases, this method offers the worst matrix cleanup and thus results in the worst matrix effect. However, the method is very simple and fast.

(b). Methyl-t-butyl ether (MTBE) (or hexane or other hydrophobic solvents): a better selectivity than the acetonitrile protein precipitation method because only hydrophobic components are extracted. Also, the method is also very simple and fast. However, the selectivity of the method is still not sufficient in most cases because the hydrophobic components from biological matrices (e.g. fat materials, phospholipids, lyso-phospholipids) are also extracted and often interfere with subsequent LC/MS/MS and GC-MS. As a matter of fact, the matrix effect from hydrophobic matrix is very difficult to be eliminated and/or compensated in the subsequent analysis.

In addition, although the extracts by the use of non-polar solvents tend to be substantially cleaners, the suitability of the method is limited to the hydrophobic drugs.

(c). Liquid-liquid extraction using the extraction cartridge: The process involves adding biological fluids to a cartridge containing an essential inert support, usually diatomaceous earth. An organic solvent is then washed through the cartridge to extract the drug from the film of the biological fluid spread over the inert support. However, the selectivity of the method is not still insufficient and the recovery of the drug is also a concern. In addition, it is difficult to use the method for the homogenized tissue matrices.

(d). On-line matrix cleanup (with column switch-on technology): Many different types of on-line SPE (and even HPLC) products such as restricted access HPLC/SPE media, turbulent flow, conventional on-line SPE and monolithic materials have been commercialized. However, their applications in the quantitative bioanalysis are highly questionable because of low selectivity. First, specifically, the use of gas chromatography (GC) with these SPE and turbulent media frequently reveals that the materials not only extract too much components from biological fluids, but also introduce new contaminants from these materials themselves. Second, the drug recovery and the significant chromatographic peak tailings are serious problems. Third, even when large peak tailings can be corrected by isocratic focusing dual column cleanup, it is no method to differentiate the matrix effect from the recovery issue. Fourth, it is nearly impossible to apply the strategy for both the homogenized tissues samples and the vitreously biological fluids. Last but most important, all the SPE/HPLC materials used in the on-line process do not have sufficient selectivity to get rid of fatty substances and phospholipids.

(e). Off-line solid phase extraction (SPE): It includes polymer-based SPE and silica-based SPE materials. However, their applications are far from satisfaction. First, almost all the SPE adsorbents except mixed-mode SPE have no generic protocols. Method development is frequently essential and the methodology is changed from case to case. Furthermore, insufficient matrix cleanup and the drug recovery issue frequently result in inaccurate results. Second, even mixed-mode SPE materials, particularly silica-based cation-mixed SPE, offers the cleanest background and high drug recovery, their applications are limited to hydrophobic and strong basic compounds in the presence of less vitreously biological fluids. Because of insufficient ion-exchange capacity (or hydrophobicity), many drugs partially lost in methanol wash. In addition, multi-steps increase the possibility for poor precision. Third, it is nearly impossible to directly apply load the homogenized tissues samples or the vitreously biological fluids onto the SPE cartridges. Fourth, generally, solid phase extraction is labor intensive, expensive and prone to operator errors. Fifth, although both silica-based cation mixed-mode SPE and strong cation exchange (SCX) sorbents possibly minimize matrix effect in some cases, their ability for minimization of ionization suppression/enhancement is highly pH-dependent. For instance, silica-based mixed-mode SPE minimizes the matrix effect at pH 5-7. However, in quantitative analysis, the precision is quite poor in many cases at neutral and weakly acidic pH (pH 3-7). In many cases, even isotopically labeled internal standards can not match the variation of the analytes. When the biological samples are loaded at acidic pH (1-2), such a variation from the same lot of biological fluid is greatly eliminated to a large degree. Unfortunately, the matrix effect from different lots becomes significant because phospholipids elute into the final fraction. As a matter of fact, the mixed-mode SPE products lose the most important merit. By the way, polymer-based cationic mixed-mode SPE frequently offers higher and more un-cleaned background than the corresponding silica-based products.

Due, in part, to the shortcomings in the current state of the art technologies, there exists an unmet need for generic, robust, rapid, selective and simple methods for satisfactory matrix cleanup. The present invention fulfills this and other related needs for thorough isolation of interference from biological matrices and quantitative analysis of basic and neutral compounds. As disclosed in detail herein below, the core of the present invention is to use weak anion exchange (WAX) adsorbents for removal of all negative and zwitterionic components in the biological matrices such as fatty substances, phospholipids, dioctyl phthalate, carbohydrates, nucleic acids, glyco-proteins, EDTA, heparin, lipids, lipid-proteins, triglycerides, glucuronides and others. These WAX adsorbents can be either incorporated into the liquid-liquid extraction step, or simply used as a separate step in combined with all the existing extraction methodologies. The WAX-enhanced extraction methods exploit the high degree of specificity and greatly remove extraneous components that would cause interference during analysis of basic and neutral drugs.

### SUMMARY OF THE INVENTION

It is an object of the present invention to overcome the aforesaid deficiencies in the prior art.

It is an object of the present invention to use weak anion exchange sorbents for matrix cleanup, by the adsorption and removal of the negative and zwitterionic components in the biological matrices (fatty substances, phospholipids, diocyl phthalate, carbohydrates, nucleic acids, glycol-proteins, EDTA, heparin, lipids, lipid-proteins, triglycerides, glucuronides and others).

It is an object of the present invention to use weak anion exchange adsorbents, either singly or in combination, for full recovery of basic and neutral compounds from biological matrices.

It is an object of the present invention to develop and protect weak anion exchange adsorbents in various formats and configurations such as dispersed sorbents, monolayer and multi-layer SPE cartridges, 96-well plates 384-well plates, turboflow, zip-tip, WAX-treated glass vials and other on-line SPE configurations, for cleanup of biological (human and animal) matrices.

It is an object of the present invention to use weak anion exchange adsorbents for cleanup of biological (i.e. human and animal matrices), and thus minimization and even elimination of the matrix effect(s) in analysis of basic and neutral compounds by LS-MS, LC-MS/MS, GC, GC-MS, HPLC and other analytical approaches.

According to the present invention, a weak anionic-exchange sorbent is used to treat a biological fluid or homogenized tissue, before or after or incubated into the liquid-liquid (or liquid-solid) extraction, and remove the negative and zwitterionic components in the biological matrices like fatty substances, phospholipids, dioctyl phthalate, carbohydrates, nucleic acids, glyco-proteins, EDTA, heparin, lipids, lipid-proteins, triglycerides, glucuronides. As compared to the existing methods for sample preparation, the process of the present invention is less expensive, easier, simpler, more reproducible and robust for treating all types of biological matrices. Furthermore, the processes of the present invention frequently offer the best outcomes for minimization and elimination of matrix effects.

### LEGENDS TO THE CAPTIONS

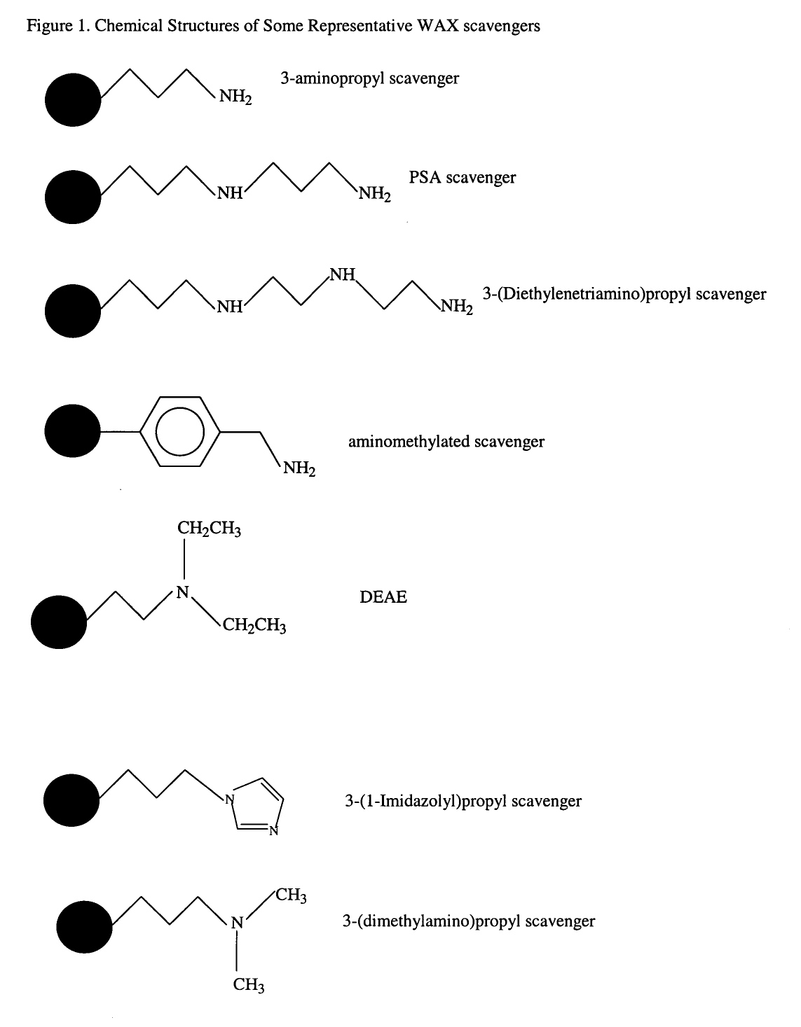

FIG. 1. Chemical Structures of Some Representative WAX scavengers

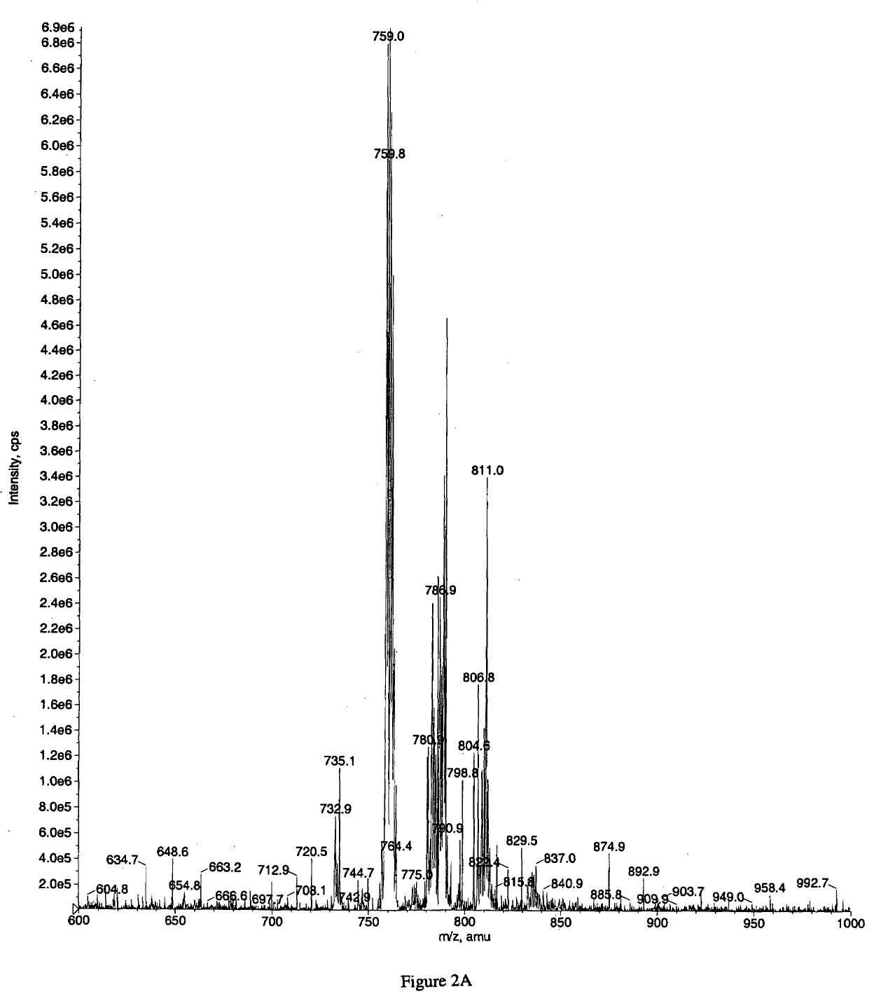

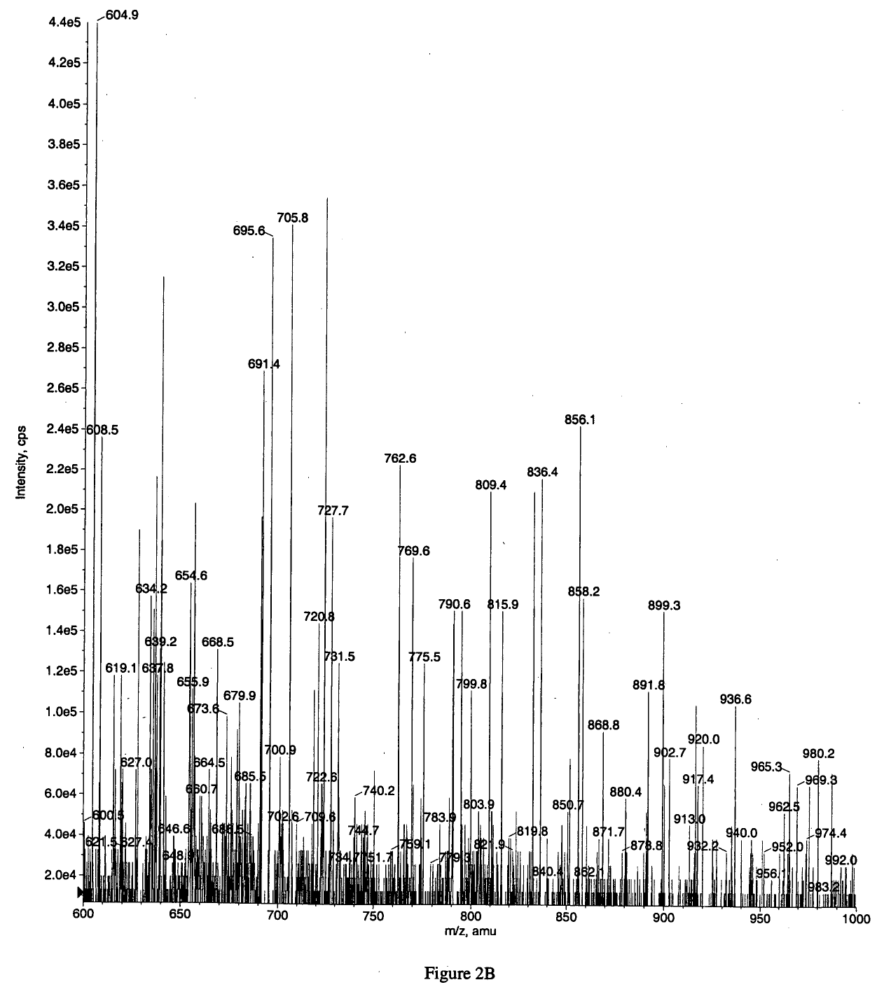

FIG. 2A. Q1 infusion data of L-alpha-phosphatidylcholine (10 ppm)

FIG. 2B. Q1 infusion data of L-alpha-phosphatidylcholine (10 ppm) after PSA treatment

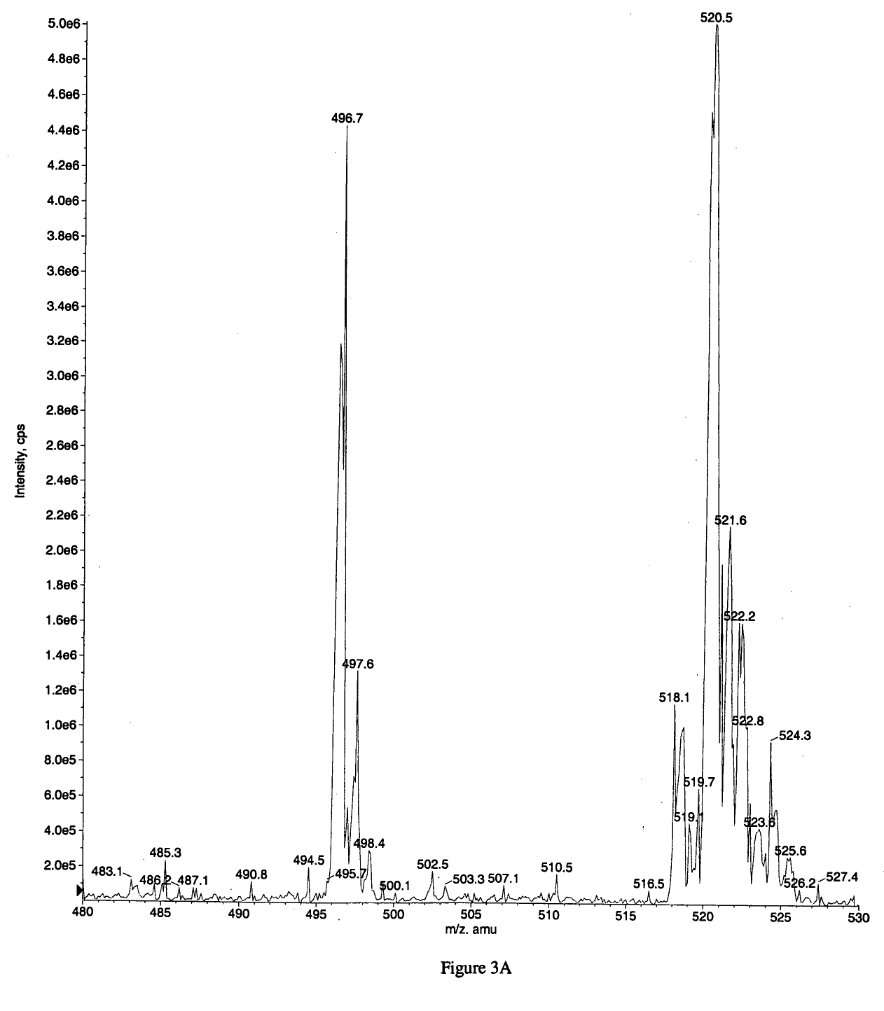

FIG. 3A. Q1 infusion data of lysophosphatidylcholine (5 ppm)

FIG. 3B. Q1 infusion data of lysophosphatidylcholine (5 ppm) after PSA treatment

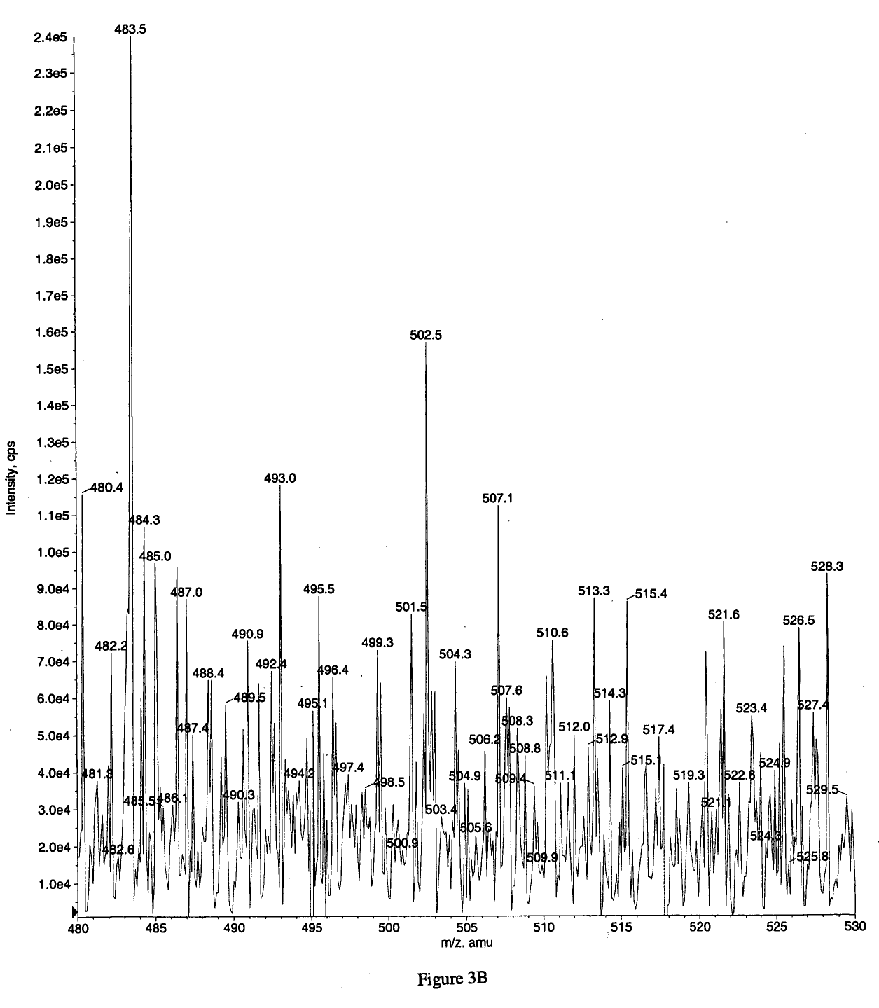

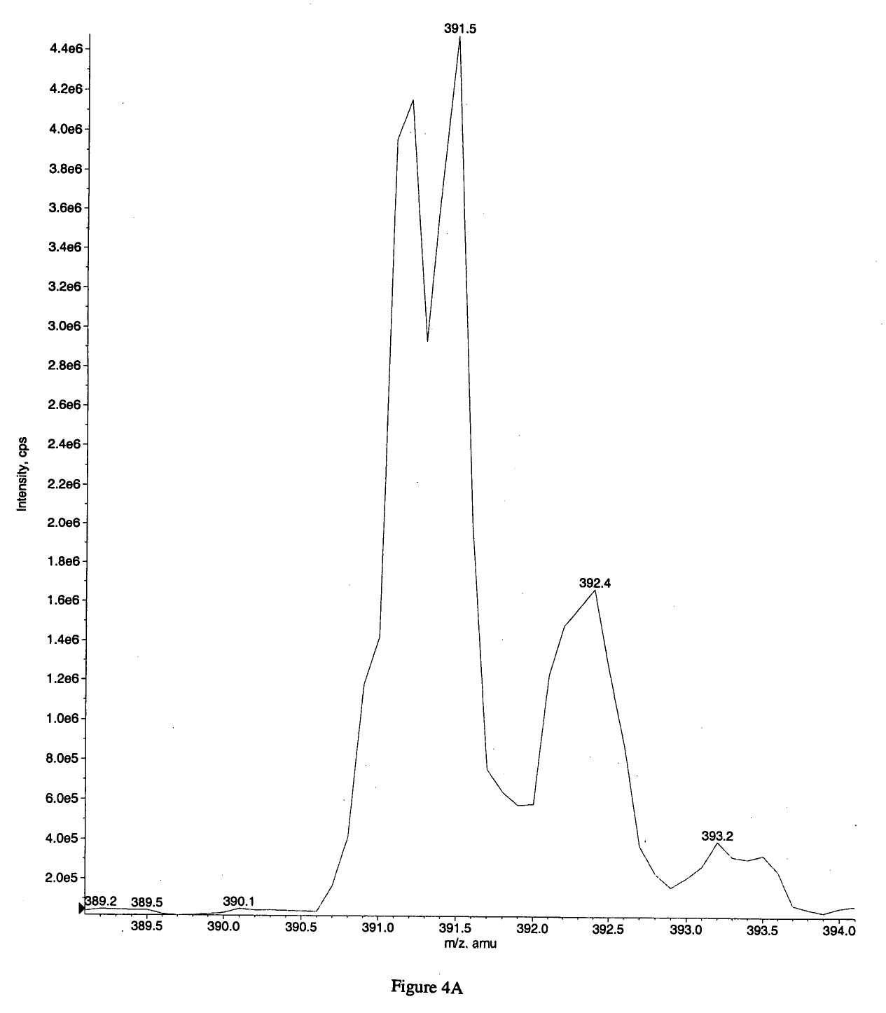

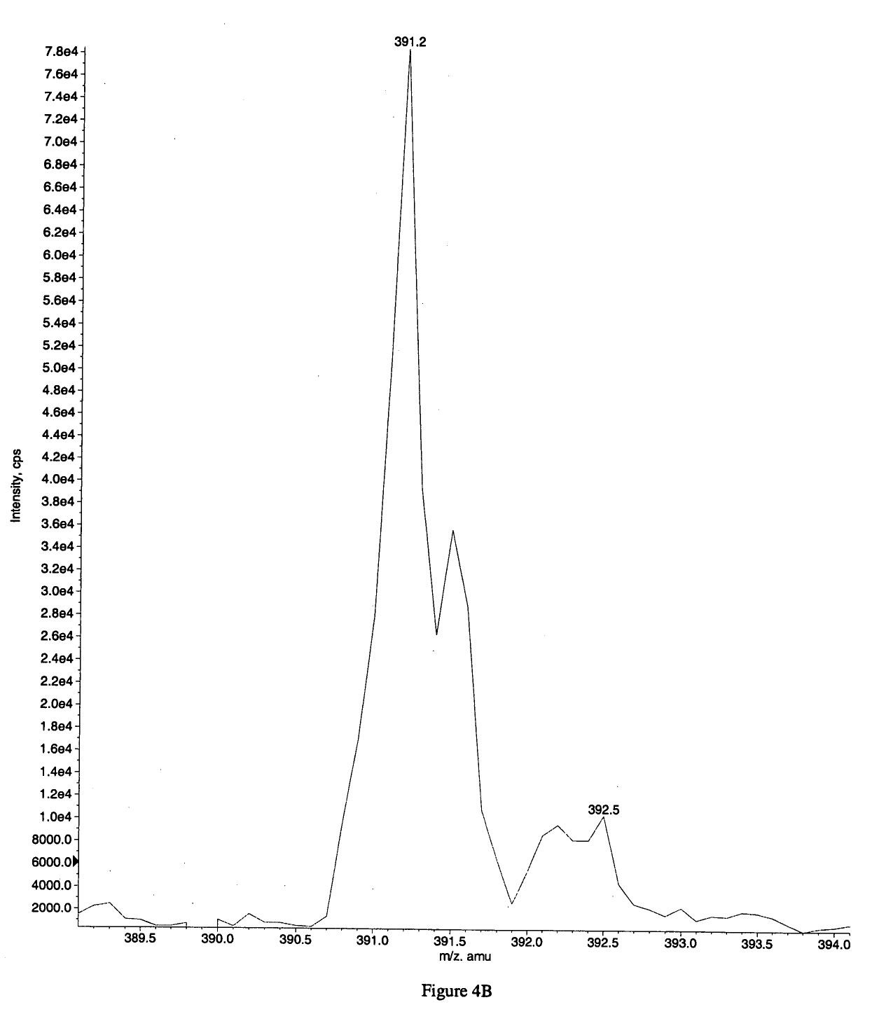

FIG. 4A. Q1 infusion data of dioctyl phthalate (2 ppm)

FIG. 4B. Q1 infusion data of dioctyl phthalate (2 ppm) after a WAX treatment

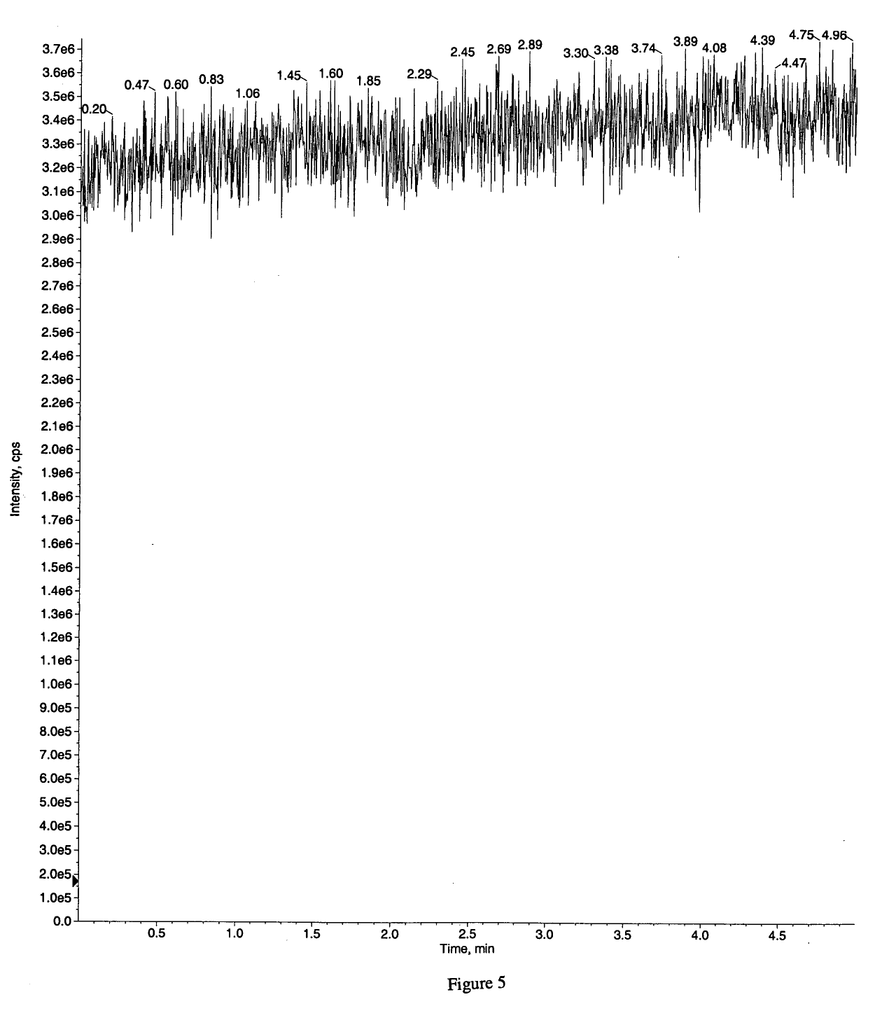

FIG. 5. Post-infusion experiment

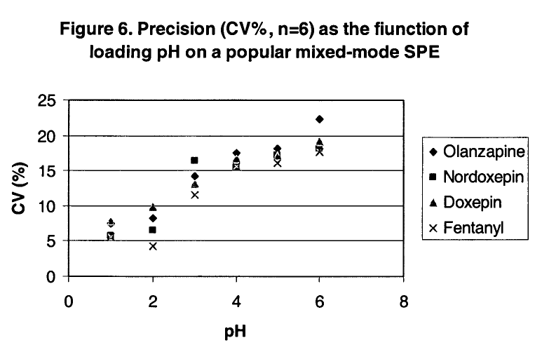

FIG. 6. Data precision vs Loading pH on a popular mixed-mode SPE

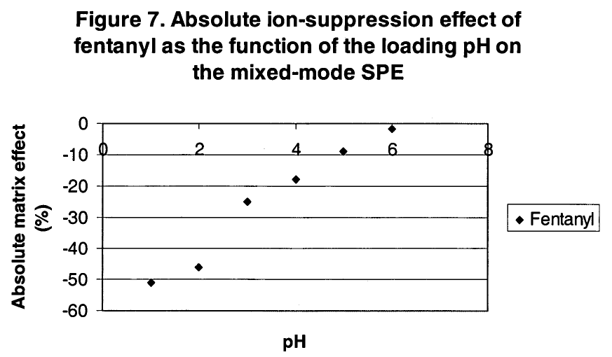

FIG. 7. Absolute ion-suppression effect of fentanyl as the function of loading pH on the mixed-mode SPE

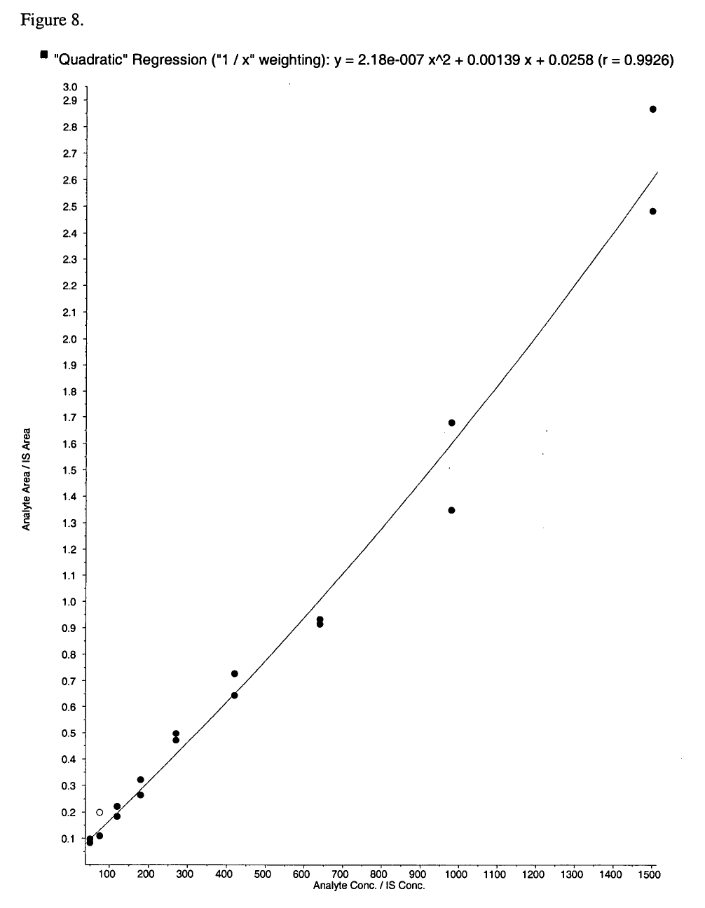

FIG. 8. LC-MS/MS matrix-matched and solution calibration curves of 5-methyl-2-pyrrolidinone

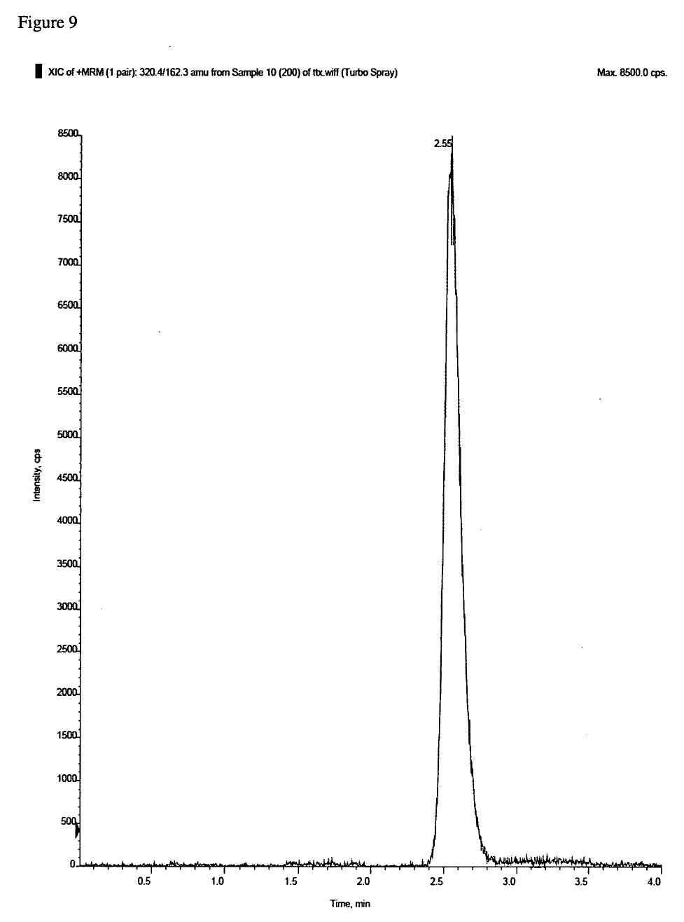

FIG. 9. LC-MS/MS MRM chromatogram of tetrodotoxin extracted from a puffer fish

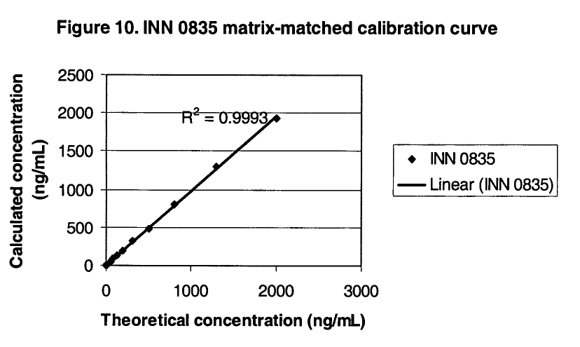

FIG. 10. INN 0835 matrix-matched calibration curve

### DETAILED DESCRIPTION OF THE INVENTION

The following detailed description are provided for purposes of describing and illustrating presently preferred embodiments of the invention only, and are not intended to limit the scope of the invention in any way.

### (a) Typical Weak Anion-Exchange Sorbents

The structures and names of some typical weak anion-exchange sorbents (both silica-based and some polymer-based ones) are listed in FIG. 1. The present invention covers and protects the applications of all types of weak anion-exchange materials for cleanup of biological (human and animal) matrices.

Most of the weak anion-exchange sorbents listed above have been extensively used as the scavenger resins in organic synthesis, water treatment and/or other industrial applications. PSA and NH₂ sorents have been extensively used for clean-up of agricultural and food products, and pesticide residue analysis (F. J. Schenck and S. J. Lehotay, J. Chromatogr. A., 2000, 868, 51-61).

However, the present invention, for the first time, proves the effectiveness of these commercial sorbents and similar materials in cleanup of biological (human and animal) matrices.

It is to be understood that while the structures of these representative sorbents shown above the invention is intended to illustrate and not to limit the scope of the appended claims. The applications of all kinds of sorbents with functional group like primary amine, secondary amine, tertiary amine, heterocyclic organic compound containing nitrogen atom or their combinatorial and modifications for cleanup of biological matrices are within the scope of the following claims.

### (b). General Methodology

A weak anion-exchange sorbent can be used at any stages of sample preparation, from the first-line treatment, intermediate treatment or last-step treatment. In addition, it can be easily incubated into protein precipitation, liquid-liquid extraction or solid phase extraction process.

Generally, a biological fluid or homogenized tissue with or without treatment is mixed with a weak anion-exchange adsorbent in aqueous, organic media or a mixed solvent. After vortexed for minutes, the basic and neutral components from the matrix is separated from the negative part of the matrix adsorbed on the weak anionic sorbent.

Alternatively, a biological fluid or homogenized tissue with or without treatment is led through a SPE cartridge composed of a weak anion-exchange adsorbent, or a mixed-mode, or a dual-layer format or a multi-layer format. When the acidic and zwitterionic components retain on the cartridges, the basic and neutral components elute from the cartridge. For high-throughput sample preparation, 96-well format or 384-well format or so is readily available.

Alternatively, a weak anion-exchange (WAX) adsorbent can be directly added during the protein precipitation or liquid-liquid extraction, make the sample preparation as one-step process. Alternatively, the protein precipitation or liquid-liquid extraction can be done using WAX-treated glass bottles and during the extraction process, the negative components from the matrix will be adsorbed on the wall of the glass. Such a process also prevents the undesired adsorption of basic drugs and metabolites onto the glass surface because of the undesired ion-exchange interaction.

### EXAMPLE I

### Infusion Experiment

Tandem Labs published a series of oral and poster presentations to conclude that endogeneous phospholipids presented in extremely high concentrations in biological matrices such as plasma are a major source for imprecision resulting from ionization suppression (P. Bennett and K C Van Horne; Presented at the 2003 AAPS Annual Meeting and Exposition, Salt Lake City, Utah, October 2003; K C Van Horne and P. Bennett; Presented at the 2003 AAPS Annual Meeting and Exposition, Salt Lake City, Utah, October 2003; K C Van Horne, M. Meng, R. Marquardt and P. Bennett, Presented at the 52nd ASMS Conference on Mass Spectrometry, Nashville, Tenn., May 2004. “Overcoming matrix effects resulting from biological phospholipids through selective extractions in quantitative LC/MS/MS,” Patrick Bennett and H. R. Liang; Presented at the 52nd ASMS Conference on Mass Spectrometry, Nashville, Tenn., May 2004. T. Zhang, M. Meng, K C Van Horne and P. Bennett, Presented at the 2005 AAPS Annual Meeting and Exposition, Nashville, Tenn., November 2005). Their researchers also show that almost all the current extraction technologies can not selectively remove phospholipids and dioctyl phthalate. In addition, they and their cooperative partner develop a lanthanide metal-based sorbents for preventing matrix effect.

The weak anion-exchange sorbents protected by the present invention greatly remove phospholipids, lysophospholipids and dioctyl phthalate.

In a typical experiment, 100 mg PSA, 3-(diethylenetriamino)propyl bonded silica or another weak anion-exchange sorbent manufactured by Chrom-Matrix Inc. was added into 2.0 ml L-α-phosphatidylcholine (10 ug/mL), lyso-phosphatidylcholine (5 ug/mL) or diocyl phthalate (2 ug/mL) acetonitrile solutions. Alternatively, the solutions of these compounds were stored in WAX-immobilized glass bottles. Vortex for 2 min. The supernatants were taken for infusion on an API 4000 MS/MS system. Some typical data were shown as FIG. 2-4.

The Q1 transition of phosphotidylcholine can be monitored at m/z 706.3, m/z 760.7, m/z 788.6 and 810.6. The product ion is at m/z 183.6. The Q1 transition of lyso-phosphatidylcholine can be monitored at m/z 496.6 and m/z 520.3. The product ion is at mix 183.6. The transition of dioctyl phthalate is m/z 390.8→149.1.

In comparison with the untreated phosphotidylcholine (FIG. 2), lyso-phosphotidylcholine (FIG. 3) and diocyl phthalate (FIG. 4), the WAX (weak-anionic exchange) treatment removes more than 95% phosphotidylcholine and lyso-phosphotidylcholine. Also, more than 90% dioctyl phthalate is also removed.

In addition, it is well known that the weak anion exchange sorbent such as aminopropyl and particularly PSA effectively remove fatty substances (Y. Liu, Journal of Liquid Chromatography & Related Technologies, in press). It is well known that aminopropyl and PSA HPLC are well suitable for removal of sugar and carbohydrates.

The infusion experiment offers a solid scientific explanation for the present invention.

### EXAMPLE 2

### Post-Infusion Experiment

The most difficult matrix effect problems are those caused by hydrophobic components with retention times that overlap the analytes. In a recent publication by PPD Development (Chin et al., Journal of Pharmaceutical and Biomedical Analysis, 2004, 35, 1149-1167), the authors indicated that lipemia, anticoagulant and their interaction significantly influenced mass spectral matrix effects and extraction matrix effects. Even with the use of isotopically labeled internal standards and high-selective mixed-mode SPE cartridge like Waters Oasis MCX, the matrix effect was too big to be compensated and thus a quantitative analysis was not reached.

In another case (Mei H. et al., Rapid Commun. Mass Spectrom., 2003, 17, 97-103), the authors revealed that the matrix effect can also be caused by exogenous materials such as Li-heparin and polymers. Thus, the authors suggested to avoid the use of Li-heparin as the anticoagulant or the corresponding plasmas or serums.

The above problem can be readily solved with the art technology of the present invention. 1.0 mL of blank human (or animal) serum, and Li-heparin, sodium citrate, and K₃EDTA plasma with various degrees of lipemia, and even whole blood, was first extracted by 5 mL of acetonitrile or MTBE in the presence of 1 gram PSA, 3-(diethylenetriamino)propyl bonded silica or another weak anion-exchange sorbent manufactured by Chrom-Matrix Inc. After vortexed and centrifuged, 4 mL of the supernatant is dried down and re-constituted into 4 mL 60% 10 mM ammonium acetate (pH 6.0) and 40% acetonitrile for the post-infusion experiment. The experimental procedure was briefly described in FIG. 5.

The test drugs include hexamidine, methylproamine, ranitidine, testosterone, cocaine, fluoxetine, Zyprexa (also called Olanzapine), rapamycin (as ammonium ion adduct), paclitaxel (as ammonium adduct), FK506, tetrodotoxin (TTX), dacarbazine, nordoxepin, doxepin, nortriptyline, amitryptyline, amphetamine, methamphetamine, propranolol, mifepristone, triprolidine, quinidine, ketoconazole, reserpine and fentanyl. No obvious ion-suppression/enhancement is observed by the post-infusion experiment.

### EXAMPLE 3

### Quantification of Ion-Suppression/Enhancement Effect

The ion suppression/enhancement effect can be calculated by Matuszewki et al.'s method (Anal. Chem., 2003, 75, 3019-3030). In more detail, the drugs were post-spiked into the biological fluids extracted by WAX-aided protein precipitation or MTBE (or another organic solvent) extraction. The integration areas of the post-spiked samples obtained from LC-MS/MS bioanalysis (API 4000 MRM positive ion mode or Agilent 1100 MSD SRM positive ion mode) were compared with those from the neat solutions at the same concentrations. The results are shown in Table 1. According to Matuszewki et al.'s method, when the matrix effect value is higher than 100%, there is a matrix enhancement effect. When the value is less than 100%, there is an ion-suppression effect. The data listed in Table 1 supports the observation from the post-infusion experiment and no obvious ion-suppression/enhancement is observed for the tested compounds when the weak anion-exchange materials invented by this patent is used with protein precipitation or liquid-liquid extraction.

TABLE 1
Process Efficiencies and Relative Matrix Effect of Some Basic Compounds

| | | | | CV |
|---|---|---|---|---|
| | | MRM | Matrix | (%) |
| Compound Name | Matrix | transition | Effect (%) | (n = 6) |
| Hexamidine | Heparinized Rat plasma | 335 → 338 | 93.4 | 5.5 |
| FK 506 | Swine Kidney | 821 → 769 | 96.5 | 11.4 |
| Rapamycin | Heparinized human plasma | 932 → 865 | 89.4 | 7.5 |
| Methylproamine | Li-Heparinized rat plasma | 466 → 450 | 104.2 | 7.7 |
| Paclitaxel | Swine liver | 854 → 286 | 108 | 13.2 |
| Tetrodotoxin | puffer fish | 320 → 162 | 97.6 | 5.3 |
| Mifepristone | Rabbit uterus | 430 → 372 | 98.3 | 8.8 |
| Testosterone | Rabbit uterus | 289 (SRM) | 99.5 | 6.4 |
| Dacarbazine | K3EDTA human plasma with Rank 4 | 183 → 138 | 90.4 | 4.7 |
| | lipemia | | | |
| Nordoxepin | K₃EDTA human plasma with Rank 4 | 266 → 235 | 99.4 | 8.7 |
| | lipemia | | | |
| Doxepin | Sodium citrate human plasma with | 280 → 107 | 92.3 | 7.2 |
| | Rank 4 lipemia | | | |
| Nortriptyline | Sodium heparin human plasma with | 264 (SRM) | 95.6 | 6.8 |
| | Rank 4 lipemia | | | |
| Amitryptyline | Sodium heparin human plasma with | 278 (SRM) | 96.3 | 6.6 |
| | Rank 4 lipemia | | | |
| Amphetamine | Racing horse blood | 143 (SRM) | 96 | 4.8 |
| Methylamphetamine | Racing horse blood | 151 (SRM) | 95.8 | 4.1 |
| Propranolol | Blank rat serum mixed with Li-heparin | 260 (SRM) | 96.5 | 7.1 |
| | (1:1) | | | |
| Triprolidine | Heparinize rat plasma | 279 → 208 | 93.7 | 5.4 |
| Quinidine | Heparinize rat plasma | 325 → 81 | 95.4 | 6.2 |
| Ketoconazole | K3EDTA human plasma with Rank 4 | 531 → 82 | 102 | 5.4 |
| | lipemia | | | |
| Reserpine | K3EDTA human plasma with Rank 4 | 610 → 195 | 105 | 7.8 |
| | lipemia | | | |
| Olanzapine | K3EDTA human plasma with Rank 4 | 313 → 256 | 109 | 6.6 |
| | lipemia | | | |
| Fentanyl | K3EDTA human plasma with Rank 4 | 337 → 188 | 96 | 4.8 |
| | lipemia | | | |
| Cocaine | Heparinize human plasma | 304 (SRM) | 95.8 | 4.3 |
| Fluoxetine | Heparinize human plasma | 282 (SRM) | 93.5 | 3.8 |

### EXAMPLE 3

### Comparison Between Cationic Mixed-Mode SPE and the Present Invention (Recovery Issue)

Prior to the appearance of the present invention, probably cationic mixed-mode SPE mode is the most powerful tool for matrix cleanup and the recovery of basic compounds. Although cation-exchange mixed-mode SPE cartridges and 96-well plates are claimed to have extremely clean backgrounds for basic drugs, their applications are severely limited to the hydrophobic and strong basic compounds. Due to the insufficient ion-exchange capacity (or hydrophobicity) of these SPE materials, polar and/or weak basic drugs and metabolites would be lost in the loading and washing steps. In addition, when the biological fluids containing basic drugs are loaded on the SPE cartridges, the degree of the matrix cleanup is very dependent on the loading pH values. When the biological fluids are loaded at neutral pH (5-7), the background of the final eluate is very clean. However, as the loading pH of the biological fluid shifts towards acidic conditions (pH 1-4) in order to retain the basic drugs on the SPE cartridges sufficiently tightly, the background of the final eluate becomes dirty and probably the matrix effect appears significantly.

WAX-aided protein precipitation or liquid-liquid extraction overcomes the severe limitation of the mixed-mode SPE materials in practical applications. Furthermore, liquid-liquid extraction and protein precipitation can be directly used for processing the homogenized tissue samples. Some recovery results are summarized in Table 2. In Table 2, some basic compounds with phenolic groups, ketone and unsaturated bonds might react with primary and second amine. However, other types of weak anion-exchange materials such as DEAE, 2-(2-pyridyl)propyl-, 3-(1-imidazolyl)propyl- or 3-(dimethylamino)propyl-functionalized silicas (or polymers) can remove the matrices and recover these compounds satisfactorily.

TABLE 2
Comparison between a cation mixed-mode SPE and WAX-enhanced protein precipitation or MTBE
for the recoveries of some polar basic compounds from biological fluids

| | | % Absolute recovery + RSD | |
|---|---|---|---|
| | | (n = 4) | % absolute recovery + RSD (n = 4) |
| | | by a popular cation mixed- | by WAX-aided protein precipitation |
| Target | Matrix | mode SPE | or MTBE extraction |
| 2-Aminopyridine | Human | 36 ± 24% | 98.7 ± 2.7% |
| | Urine | | |
| Piroxicam | Human | 75 ± 18% | 97.3 ± 2.4% |
| | Urine | | |
| Selegiline | Human | 49 ± 4.3% | 95.4 ± 3.3% |
| | plasma | | |
| 3-Pyridylacetontrile | Rat | 34 ± 28% | 92.6 ± 4.3% |
| | Plasma | | |
| Dacarbazine | Rat plasma | trace amount | 97.5 ± 4.1% |
| Buprenorphine | Human | 86 ± 6.4% | 92.3 ± 3.8% |
| | plasma | | |
| 6-Monoacetyl morphine | Human | 84 ± 7.4% | 94.1 ± 4.5% |
| | plasma | | |
| Dihydroetorphine | Human | 78 ± 8.4% | 92.6 ± 4.2% |
| | plasma | | |
| Morphine | Human | 69 ± 15% | 96.4 ± 4.8% |
| | plasma | | |
| Diazepam | Dog | 67 ± 8.2% | 91.2 ± 3.4% |
| | plasma | | |
| Estazolam | Dog | 62 ± 9.4% | 90.5 ± 4.1% |
| | plasma | | |
| Oxazepam | Dog | 43 ± 14% | 88 ± 3.5% |
| | plasma | | |
| R(-)-Salbutamol | Dog | 66 ± 7.5% | 94.2 ± 3.3% |
| | plasma | | |
| Clenbuterol | Human | 72 ± 11% | 89.4 ± 5.2% |
| | urine | | |
| %-Amino-4- | Human | trace amount | 96.7 ± 3.4% |
| imidazolecarboxamide | plasma | | |
| R(-)-Terbutaline | Human | 38 ± 14% | 86.5 ± 4.9% |
| | urine | | |

Note:
Note:
(1) When the mixed-mode SPE product was used for the matrix cleanup and the recovery of the compounds, t [symbol] loading pH was optimized in order to achieve the highest recovery. Only the fractions eluted by 95% methanol and 5 [symbol] ammonium hydroxide were collected and re-constituted for further HPLC analysis.
(2). When WAX was used to enhance the selectivity of the protein precipitation or MTBE extraction, no pH adjustment was required although water itself may play a vital role to eliminate the hydrophilic interaction between some compounds and WAX.
(3). The spiked concentration of each compound was 0.5 ug/mL. The calibration standards were made in the HPI [symbol] mobile phases and run before and after the extracted samples. The HPLC methods made the retention times of the [symbol] compounds far from the front solvent peaks and the matrix peaks. Instrument: Agilent 1100 HPLC system with [symbol] detector. Column dimension: 10 cm × 1.0 mm. [symbol]
indicates data missing or illegible when filed

### EXAMPLE 4

### Comparison Between Cationic Mixed-Mode SPE and the Present Invention (Ion-Suppression Issue)

In comparison with the mixed-mode SPE cleanup process, WAX-aided protein precipitation or liquid-liquid extraction is not only cost-effective and free of risk for loss of the basic compounds, but also frequently offers more precise results. Two sample preparation methods, PSA-aided protein precipitation and a popular mixed-mode SPE, were developed for a rat plasma cleanup and the LC-MS/MS (Sciex API-4000) quantitative analysis of olanzapine, nordoxepin, doxepin and fentanyl. Fentanyl-d₅ was used as the internal standard. All the four compounds do not have recovery issue on the silica-based C8+SCX mixed-mode SPE at acidic and neutral pH. The precision was poor when the compounds were loaded at neutral pH according to the manufacturer's manual (FIG. 6). According to FDA biological validation guidance, the precision must be equal or less than 15%, thus when the mixed-mode SPE was used as the matrix cleanup, the compounds had to be loaded on the SPE cartridges or 96-well plates at pH 1-2. Unfortunately, at such a low pH, the absolute matrix effect became significant and the relative matrix effects from six unique lots were frequently out of range. As a typical example, the performance of fentanyl was depicted as FIG. 7. By the way, polymer-based mixed-mode SPE frequently offers even worst results.

The present invention applied MTBE extraction, followed by a 3-(diethylenetriamino)propyl bonded silica treatment in acetonitrile. The absolute matrix effects were nearly zero. In addition, the extraction method developed by the invention was much cheaper and simple.

### EXAMPLE 5

### LC-MS/MS Analysis of 5-methyl-2-pyrrolidinone

Cattle liver tissue spiked with 5-methyl-2-pyrrolidinone was extracted by acetonitrile. One portion was directly injected for LC-MS/MS analysis when the other portion was led through a PSA cartridge for further cleanup. The PSA cleanup offered ten times higher sensitivity because of the elimination of the matrix effect. Since the matrix effect was absent, the solution calibration standard curve fits well with that from the matrix-matched calibration standard (FIG. 8).

### EXAMPLE 6

### Combination Between C8+SCX Mixed-Mode SPE and PSA for Matrix Cleanup

In this example, simultaneous extraction and analysis of basic analytes with diverse structures in the biological fluids are presented. Fentanyl, ritonavir, naltrexone, loratadine, dacarbazine, 5-amino-4-imidazolecarboxamide and 5-aminoimidazole-4-carboxamidoxime are selected as the test compounds. Fentanyl-d₅ is used as the internal standard and an amide-80 hydrophilic interaction chromatography with Sciex API 4000 tandem mass detector is used for bioanalysis. Simultaneous extraction of these compounds from biological fluids can be done by WAX-enhanced protein precipitation. However, dacarbazine and its final metabolite, 5-amino-4-imidazolecarboxamide, remains unstable just by liquid-liquid extraction. Thus, the drugs and metabolites were first treated by Chrom-Matrix silica-based C8+SCX mixed-mode SPE in order to extend the extraction ability (72 hours). Then the matrix effects from different human plasma lots were eliminated by a PSA treatment process. Although Fentanyl-d₅ has very different physic-chemical properties, the established extraction process was so robust that the role of the internal standard was to just track the injection repeatability.

The QC data regarding Dacarbazine, a powerful cancer drug, are presented in Table 3 as the example.

TABLE 3
The precision and accuary of QC samples from seven different lots of human plasma spiked with DTIC

| | | | LOW- | LOW- | LOW- | LOW- | LOW- | LOW- | | |
|---|---|---|---|---|---|---|---|---|---|---|
| | | | QC | QC | QC | QC | QC | QC | | |
| | LLOQ | LOW | Lot 1 | Lot 2 | Lot 3 | Lot 4 | Lot 5 | Lot 6 | MID | HIGH |
| Theor. Conc. | 5.00 | 15.0 | 15.0 | 15.0 | 15.0 | 15.0 | 15.0 | 15.0 | 75.0 | 300 |
| #1 | 4.89 | 15.6 | 14.5 | 16.4 | 16.7 | 15.0 | 13.4 | 16.3 | 71.9 | 292 |
| #2 | 5.43 | 15.9 | 14.9 | 16.3 | 15.5 | 16.2 | 14.7 | 16.4 | 78.9 | 319 |
| #3 | 5.31 | 16.2 | 13.9 | 17.2 | 15.9 | 16.4 | 17.0 | 16.7 | 81.4 | 286 |
| #4 | 4.96 | 15.8 | 16.1 | 19.6^{a} | 16.2 | 16.4 | 15.8 | 16.1 | 79.2 | 314 |
| #5 | 5.48 | 16.0 | 15.5 | 17.1 | 15.0 | 16.9 | 15.5 | 15.9 | 80.3 | 288 |
| Mean | 5.21 | 15.9 | 15.0 | 17.3 | 15.9 | 16.2 | 15.3 | 16.3 | 78.3 | 300 |
| S.D. | 0.272 | 0.224 | 0.856 | 1.34 | 0.650 | 0.709 | 1.34 | 0.303 | 3.73 | 15.5 |
| % CV | 5.2 | 1.4 | 5.7 | 7.7 | 4.1 | 4.4 | 8.8 | 1.9 | 4.8 | 5.2 |
| % Theoretical | 104.2 | 106 | 100 | 115.3 | 106 | 108 | 102 | 108.7 | 104.4 | 100 |
| n | 5 | 5 | 5 | 5 | 5 | 5 | 5 | 5 | 5 | 5 |

^{a}= Value outside of acceptance criteria but included in summary statistics

The LOW-QC data from the bulk plasma are very identical with those from six unique plasma, implying the absence of the relative matrix effect. The extracted samples have three-day extraction stability at 4° C.

The column clogging is frequently a headache problem when SPE cartridges are used to treat vitreously biological fluids. An additional benefit is that after the WAX treatment (even simply mix the matrix with WAX, without acetonitrile/MTBE), the cleaned matrix is much easier to pass through the SPE cartridges.

### EXAMPLE 7

### Method Development and Validation for LC-MS/MS Bioanalysis of Paclitaxel from Porcine Liver

In a bioanalytical GLP validation study, the concentrations of paclitaxel in liver samples need to be accurately measured by LC/MS/MS. Two CRO labs failed in the method development.

By the present invention, a simple and robust extraction method was successfully developed. After the homogenization of the liver samples, MTBE liquid-liquid extraction was used to extract paclitaxel. Just by the MTBE extraction or other conventional methods, the matrix effect is too big to be compensated even when the isotope-labeled internal standard was used. In order to solve the problem, the MTBE extracts are dried and re-constituted in acetonitrile:water (90:5). 100 mg PSA is added and it is found that a lot of grease impurities are removed by PSA. Then the supernatants are dried for further LC-MS/MS analysis. The matrix effect was measured by the use of post-spiked matrix samples and the neat solutions, and was proven to be eliminated (<5%).

### EXAMPLE 8

### LC-MS/MS Method Development and Validation for Determination of Rapamycin in Whole Blood

A simple and robust GLP LC-MS/MS method was successfully developed and validated for the determination of rapamycin in whole blood. The extraction method was briefly described as follow. 200 mL of the whole blood was extracted by 1 mL ethyl acetate:n-butyl chloride (1:1). The organic layer was separated and dried. The extracted residues were re-constituted in 0.5 mL acetonitrile:water (95:5) and led through a 96-well plate containing 200 mg 3-(diethylenetriamino)propyl bonded silica. The eluate was dried and re-constituted for LC-MS/MS bioanalysis.

No relative matrix effect was observed, as shown in Table 4.

TABLE 4
The precision and accuary of QC samples from seven different
lots of human plasma spiked with Rapamycin

| | LOW | LOW QC | LOW | LOW | LOW QC | LOW |
|---|---|---|---|---|---|---|
| Data | QC 1 | 2 | QC 3 | QC 4 | 5 | QC 6 |
| Expected | 10.00 | 10.00 | 10.00 | 10.00 | 10.00 | 10.00 |
| Conc. | | | | | | |
| Number Of | 6 of 6 | 6 of 6 | 6 of 6 | 6 of 6 | 6 of 6 | 6 of 6 |
| Values Used | | | | | | |
| Data | 8.89 | 9.36 | 8.83 | 10.91 | 10.29 | 10.4 |
| Point #1 | | | | | | |
| Data | 10.87 | 9.96 | 9.55 | 10.44 | 10.38 | 10.81 |
| Point #2 | | | | | | |
| Data | 10.8 | 11.17 | 9.59 | 8.82 | 9.98 | 11.42 |
| Point #3 | | | | | | |
| Data | 10.17 | 10.84 | 11.01 | 10.72 | 9.7 | 10.94 |
| Point #4 | | | | | | |
| Data | 9.64 | 10.09 | 10.02 | 8.09 | 9.49 | 9.22 |
| Point #5 | | | | | | |
| Data | 8.88 | 9.89 | 11.13 | 9.87 | 10.3 | 10.39 |
| Point #6 | | | | | | |
| Mean | 9.87 | 10.22 | 10.02 | 9.81 | 10.02 | 10.53 |
| Low | 8.88 | 9.36 | 8.83 | 8.09 | 9.49 | 9.22 |
| High | 10.87 | 11.17 | 11.13 | 10.91 | 10.38 | 11.42 |
| Standard | 89.0 | 66.6 | 89.8 | 113 | 36.3 | 74.8 |
| Dev. | | | | | | |
| % CV | 9.00 | 6.51 | 8.95 | 11.5 | 3.62 | 7.10 |
| Accuracy | 98.79 | 102.2 | 100.2 | 98.11 | 100.3 | 105.4 |

### EXAMPLE 9

### Development of a GLP-Based LC-MS/MS Analysis for Determination of Tetrodotoxin from Various Biological Matrices

GLP-based LC-MS/MS bioanalysis has been successfully developed by the author to accurately detect trace amount of tetrodotoxin in puffer fishes, microorganisms, crabs, patients's blood and urine. The study is in support of drug development, optimization of purification arts, and acting as the worldwide standard method for the determination of tetrodotoxin. WAX sorbents was proven as the sole method for elimination of the matrix effect. With the use of right WAX sorbents, the MS/MS sensitivity was 3.6 times higher than without WAX.

The representative LC-MS/MS chromatogram was shown as FIG. 9.

### EXAMPLE 10

### Use of WAX-Immobilized Glass Vials for HPLC and LC-MS/MS Analysis of Basic Drugs

Many basic drugs can not be quantitatively extracted in conventional glassware. In addition, the most common used sample vials for regular HPLC analysis are composed of glasses and these vials offered irreproducible results. It is because the basic drugs have non-specific and irreversible adsorption on glass walls because of undesired silanol activity.

The current method for silanization of glass vials use the end-capping reagents that are routinely used for end-capping of reversed HPLC stationary phases. The methods can not block the silanol activity completely. Also, as side effect, the treatment makes the glass vials more hydrophobic. In addition, the end-capping process is unstable and a part of reagents, revealed by GC-MS analysis, released into the sample solutions.

The present invention protects WAX-immobilized glass vials. The WAX immobilization process includes a two-step curing process, ensuring the monolayer chemical immobilization of WAX silanized reagents. The bleeding was very difficult to be detected from the patented sample vials. The WAX-immobilized sample vials offer two merits. First, it prevents the undesired adsorption of basic drugs on the glass walls due to electronic-electronic repulsion interaction. Second, it reduces the matrix effect in LC-MS/MS bioanalysis. The WAX-immobilized glass vials should be very valuable in the applications of quantitative HPLC and LC-MS, LC-MS/MS applications.

An antidepressant pentapeptide INN 00835 (J. P. Feighner et al. Biopharmaceutics & Drug Disposition, 2002, 23: 33-39) was supposed to be weak basic. However, its neat solution can not be plotted as a linear calibration curve when the conventional glass vials was used. It was because the compound had an undesired adsorption on the glass walls. The situation was particularly true at low concentration range. When WAX-immobilized glass vials made by Chrom-Matrix Inc. were used instead, both neat solution calibration curve and the extracted matrix-matched calibration curve looked excellent. A representative calibration curve obtained by a LC-MS/MS bioanalysis was shown as FIG. 10.

### Other Embodiments

From the description above, one skilled in the art can ascertain the essential characteristics of the invention and without departing from the spirit and scope thereof, can make various variations and modifications of the invention to adapt it to various usages and conditions.

It is to be understood that while the invention has been described in conjunction with the detailed description thereof, the form of the present invention described above and shown in the figures of the accompanying drawing is illustrate only and is not intended to limit the scope of the appended claims. Other aspects, advantages, and modifications are within the scope of the following claims.

All references cited in this specification are hereby incorporated by reference.

What is claimed is:

1. A method for reducing the biological matrix effect in the quantitative determination of basic and neutral compounds present in the matrix. The method comprising the step of:
a) Adding a weak anion exchange material to said biological matrix before or after or during the treatment by the conventional sample preparation processes such as protein precipitation, liquid-liquid extraction, solid phase extraction, extraction cartridge or so
or
b) Lead the biological fluid and/or tissue homogenate through a weak anion-exchange cartridge, 96-well plate or turboflow or zip tip or other formats of configuration
or
c) Lead the biological fluid and/or tissue homogenate through dual-layer, or multi-layer or mixed-bed configurations of SPE cartridges and well plates, wherein weak anion-exchange materials exist.
Wherein the negative and zwitterionic interference from biological matrices are trapped on the weak anion-exchange sorbents while the basic and neutral compounds of interest pass through.
d) Use of WAX-coated glass vials wherein the negative and zwitterionic interferences from the extracted matrices are trapped on the glass walls when such a coating prevents the non-specific adsorption of basic compounds due to the undesired silanol activities of glass vials

2. The method of claim 1, wherein said biological matrix is human or animal fluid and tissue.

3. The said fluid and tissue of claim 2 is blood, serum, plasma, urine, bile, semen, mucal scrapings, sweat, liver, brain, hair, bone, pus, saliva, fecal matter, biopsy tissue, autopsy tissue, amniotic fluid, synovial fluid, blood-stained materials, prokaryotic cultures or eukaryotic cultures.

4. The said tissue of claim 3 is homogenized.

5. The method of claim 1, wherein said weak anion-exchange material is an inorganic sorbent with functional group like primary amine, secondary amine, tertiary amine, heterocyclic organic compound containing nitrogen atom or their combinatorial.
